(19) United States
(12) Patent Application Publication
(10) Pub. No.: US 2026/0019939 A1
(43) Pub. Date: Jan. 15, 2026

(54) ACCESS POINT RECOMMENDATION FOR ACCESS POINT POWER SAVE

(71) Applicant: Cisco Technology, Inc., San Jose, CA (US)

(72) Inventors: Binita GUPTA, San Diego, CA (US); Brian D. HART, Sunnyvale, CA (US); Domenico FICARA, Essertines-Sur-Yverdon (CH); Vishal S. DESAI, San Jose, CA (US)

(21) Appl. No.: 19/269,986

(22) Filed: Jul. 15, 2025

Related U.S. Application Data
(60) Provisional application No. 63/671,618, filed on Jul. 15, 2024.

(51) Int. Cl. H04W 52/02; H04W 40/24; H04W 76/20

(52) U.S. Cl. CPC H04W 52/0203; H04W 40/248; H04W 76/20

(57) ABSTRACT

Techniques for optimizing wireless connectivity between access points and associated stations. The techniques include determining, at an access point, to enter a power save mode at a future period of time. The techniques further include generating, at the access point, a connectivity recommendation of one or more alternative connection points for maintaining wireless service among one or more stations associated with the access point. The techniques further include transmitting, prior to entering the power save mode, the connectivity recommendation to the one or more stations associated with the access point.

### CROSS-REFERENCE TO RELATED APPLICATIONS

This application claims benefit of co-pending U.S. provisional patent application Ser. No. 63/671,618 filed Jul. 15, 2024. The aforementioned related patent application is herein incorporated by reference in its entirety.

### TECHNICAL FIELD

Embodiments presented in this disclosure generally relate to wireless communications. More specifically, embodiments disclosed herein relate to optimizing wireless connectivity between access points and associated stations.

### BACKGROUND

Devices, such as mobile phones, tablets, laptop computers, etc., are becoming increasingly more capable, integrated with a variety of functions which may include Bluetooth, Wi-Fi, and LTE capabilities. For example, these devices may regularly connect to Wi-Fi services, such as via an access point. In some cases, the access points may be equipped with power save capabilities which enable the access points to reduce their power consumption (e.g., by shutting down the access point, shutting down a particular link of the access point, reducing power on one or more links of the access point, etc.). Such practices may result in devices associated with the access point suddenly losing connectivity or experiencing reduced performance (e.g., slower download speeds, etc.) when the access point enters a power save mode. With both personal and business transactions across the world relying heavily on steady access to wireless communication, even minor or temporary disruptions in service may cause significant ramifications. Thus, there is a need for techniques for minimizing the disruptive effects of access point power save operations.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example access point (AP) and one or more connected devices with Wi-Fi capabilities, according to some embodiments of the present disclosure.

FIG. 2 illustrates an example architecture of a multi-link device (MLD), according to certain embodiments.

FIG. 3 depicts an example AP providing a connectivity recommendation to a connected STA, according to some embodiments of the present disclosure.

FIG. 4 depicts an example method in which the associated AP generates the connectivity recommendation which is provided to one or more connected STAs, according to some embodiments of the present disclosure.

FIG. 5 is a flow diagram depicting an example method 500 for optimizing wireless connectivity, according to some embodiments of the present disclosure.

FIG. 6 depicts an example network device 600 configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

Embodiments described herein include a method. The method includes determining, at an access point, to enter a power save mode at a future period of time. The method further includes generating, at the access point, a connectivity recommendation of alternative connection points for maintaining wireless service among one or more stations associated with the access point. The method further includes transmitting, prior to entering the power save mode, the connectivity recommendation to the one or more stations associated with the access point.

Embodiments further include a system, including one or more processors and one or more memories storing a program, which, when executed on any combination of the one or more processors, performs operations. The operations include determining, at an access point, to enter a power save mode at a future period of time. The operations further include generating, at the access point, a connectivity recommendation of alternative connection points for maintaining wireless service among one or more stations associated with the access point. The operations further include transmitting, prior to entering the power save mode, the connectivity recommendation to the one or more stations associated with the access point.

Embodiments further include a non-transitory computer-readable medium containing computer program code that, when executed by operation of one or more computer processors, performs operations. The operations include determining, at an access point, to enter a power save mode at a future period of time. The operations further include generating, at the access point, a connectivity recommendation of alternative connection points for maintaining wireless service among one or more stations associated with the access point. The operations further include transmitting, prior to entering the power save mode, the connectivity recommendation to the one or more stations associated with the access point.

### EXAMPLE EMBODIMENTS

Aspects of the present disclosure provide apparatuses, methods, processing systems, and computer-readable mediums for optimizing wireless connectivity between APs and associated STAs.

Nowadays, APs support a number of STAs (e.g., mobile phones, tablets, laptop computers, etc.) that are connected to the APs for wireless services, such as Wi-Fi. Increasingly, the APs are equipped with power save capabilities which allow the APs to wholly or partially shut down operations to conserve power (e.g., during downtime hours, to meet power usage limitations, etc.). Entering a power save without warning or providing an indication of other available means for connecting to wireless services, however, may result in STAs losing connectivity or STAs left with reduced performance (e.g., slower download speeds, etc.), which can have substantial impacts.

To improve wireless connectivity between APs and associated STAs, techniques described herein generate a connectivity recommendation at an AP and provide it to connected STAs before the AP enters into a power save mode, notifying the STAs in advance of alternative connection points (e.g., other active links, APs, etc.) and enabling the STAs to switch to those connection points in order to maintain optimal connectivity.

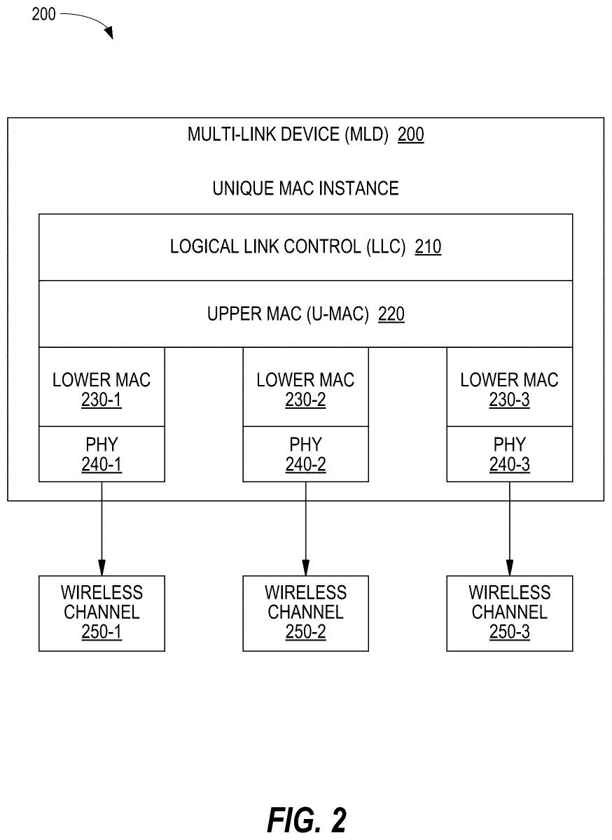

For example, an AP first determines that a power save mode is to be initiated at a future period of time. The AP may be a single AP or an AP multi-link device (AP MLD). An AP MLD may comprise multiple links, or support multiple frequency bands (e.g., 2.4 GHZ, 5 GHZ, and 6 GHZ), to which STAs, or devices, may connect for wireless service, as depicted below with respect to FIG. 2. In some embodiments, the power save mode includes shutting down the AP/AP MLD or a subset of the links thereof. In other embodiments, the power save mode includes an AP remaining operational (i.e., not shutting down), but at a lower capacity than during a fully active mode.

The AP then generates a connectivity recommendation containing a list of other connection points (e.g., nearby APs or links of the AP not entering power mode) to which STAs may connect in order to receive uninterrupted wireless service. The connectivity request may also contain an indication of the type of power save mode, a schedule for the power save mode (e.g., start time, duration, etc.), and/or a reason for entering the power save mode. This additional information may further help inform the STAs of the optimal action(s) to take.

Once the connectivity recommendation is generated, the AP transmits the connectivity recommendation to one or more STAs associated with the AP (e.g., connected STAs receiving wireless service from the AP). The connectivity recommendation may be transmitted via a basic service set transition management (BTM) request frame or a neighbor report response frame. In some embodiments, the transmitting is based on one or more features of each STA of the STAs associated with the AP, such as the type of STA (e.g., ultra-high reliability (UHR) devices, extremely high throughput (EHT) devices, legacy devices, etc.). In one embodiment, the connectivity recommendation is transmitted prior to the AP entering the power save mode, notifying the STAs in advance and providing them time to make alternative arrangements for remaining connected to wireless services (e.g., switching links, APs, and/or the like).

These techniques optimize wireless connectivity for STAs and APs as STAs receive advance notice of alternative connection points and can prepare for upcoming power save by their associated AP (e.g., by switching to an available link or AP), while the AP can retain power saving functionality without causing significant disruptions in service.

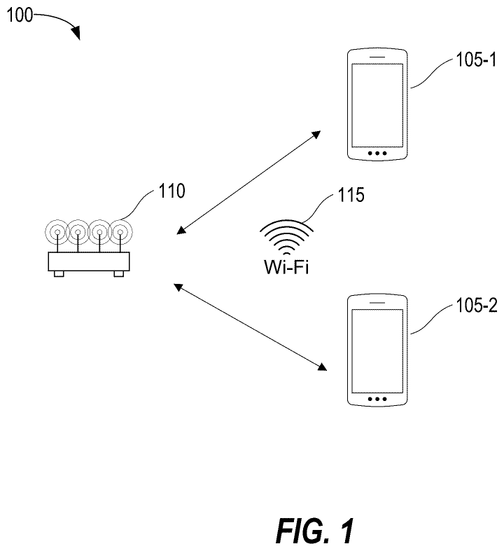

FIG. 1 depicts an example AP and one or more connected devices with Wi-Fi capabilities, according to some embodiments of the present disclosure.

As depicted, STA 105-1 and/or STA 105-2 connects to AP 110 as a client in a basic service set (BSS). Through this wireless connection 115 (e.g., a Wi-Fi connection), STAs 105-1 and 105-2 gain access to the broader network infrastructure (e.g., Internet). This connection 115 follows a Wi-Fi infrastructure mode, where AP 110 manages the communication between STAs and other devices on the network and coordinates transmission timing and resource allocation.

In this figure, STAs 105-1 and 105-2 are depicted as mobile phones, which is provided for conceptual clarity. In some embodiments, STAs 105-1 and 105-2 may be any other wireless communication devices, such as laptops, tablets, smartwatches, any other portable or stationary devices configured with wireless communication technologies, or a combination thereof. In certain embodiments, there may be additional devices or fewer devices connected to AP 110 than depicted in this figure.

The depicted wireless technologies, including Wi-Fi for infrastructure connections 115, are provided as examples for conceptual clarity. In some embodiments, STAs 105-1 and/or 105-2 may support additional wireless communication interfaces, including Bluetooth (used for low-power, short-range data exchange, such as audio streaming, peripheral device pairing, or file transfers), Ultra-Wideband (used for high-precision spatial awareness and data synchronization, such as indoor positioning, secure keyless access, or high-speed data transfer between devices), Wi-Fi Direct (used for high-speed and medium-range data transfer, such as sharing large files or streaming high-quality media between devices), Wi-Fi for off-channel docking (used for wireless display mirroring, data transfer, or peripheral connections to a docking station) or Near Field Communication (NFC) (for short-range authentication and data exchange).

In some embodiments, STAs 105-1 and/or 105-2 may utilize a multi-link operation (MLO) setup, where the devices maintain simultaneous connections to AP 110 over multiple frequency bands. For example, STA 105-1 may simultaneously establish three concurrent links with AP 110, including one link on the 2.4 GHz band (for longer range and lower power consumption), one link on the 5 GHz band (for higher throughput and reduced interference), and one link on 6 GHz band (for ultra-fast and low-latency communication).

In order to enable power save operations at the AP 110 while also maintaining steady connectivity between the AP 110 and STAs 105-1 and 105-2, the AP 110 may generate a connectivity recommendation and provide the connectivity recommendation to STAs 105-1 and 105-2 prior to entering a particular power save mode, notifying STAs of alternative connection points (e.g., other links of the AP not in power save, other available APs, etc.) for continued service. Further details about generating and providing the connectivity recommendation are discussed below.

FIG. 2 illustrates an example architecture of a MLD 200, according to certain embodiments. The MLD 200 may be an AP MLD or a STA MLD. As depicted in FIG. 2, the MLD 200 provides a unique MAC instance to multiple wireless interfaces (e.g., wireless channels 250 1-N), each of which may be utilized by a respective “radio” (e.g., AP 110 or STA 105-1). The MLD 200 includes a logical link control (LLC) layer 210 and an upper MAC (U-MAC) layer 220. The upper MAC layer 220 is a common part of the MAC sub-layer for all the interfaces (e.g., wireless channels 250 1-N). The MLD 200 also includes a respective lower MAC (L-MAC) 230 1-N for each interface. Each respective L-MAC 230 manages a corresponding physical (PHY) layer 240 as well as link specific functionalities (e.g., channel access) for the corresponding wireless channel 250 (e.g., link).

A MLD may generally be classified based on whether it is a single radio MLD or multi-radio MLD. Single radio MLDs generally use a single radio to switch between one or more links. One category of single radio MLDs is Enhanced Multi-Link Single Radio (eMLSR). eMLSR devices generally operate one main wireless radio that can transmit and/or receive data frames on a given link, but can detect some data (e.g., short initial frames) on a set of other links when the device is not actively transmitting or receiving. Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual links can operate independently of each other. For non-STR MLDs, operation on one link may be restricted by operation on another link. For example, a transmission on one link may not be allowed if it will cause reception interruption on another link. In another example, a reception or CCA on one link may not be allowed if a transmission is ongoing on another link. As used herein, the term “radio” may refer to the capability to connect to a peer device on a link and may include multiple physical radios and/or multiple logical radios enabled by a single physical radio.

According to some embodiments, the MLD 200 may comprise an AP MLD providing wireless service via one or more of the wireless channels 250 to one or more connected STAs. The AP MLD may generate and transmit a connectivity recommendation to the connected STAs prior to entering a power save mode on one or more of the channels 250, as described in more detail below.

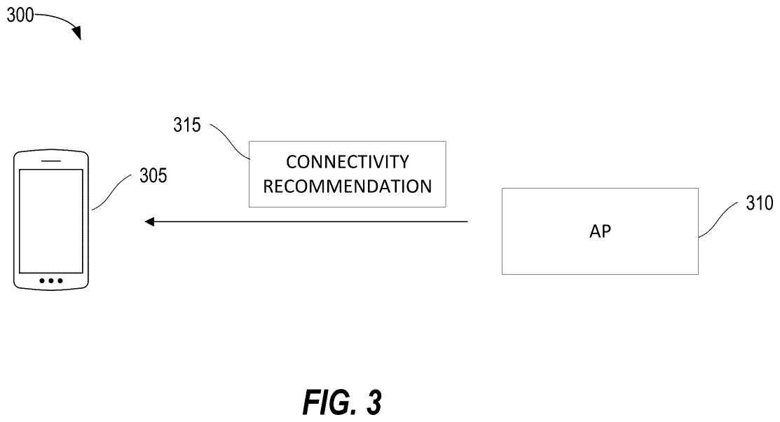

FIG. 3 depicts an example AP providing a connectivity recommendation to a connected STA, according to some embodiments of the present disclosure.

As depicted, AP 310 (which may correspond to AP 110 of FIG. 1 or an AP MLD corresponding to MLD 200 of FIG. 2) sends a connectivity recommendation 315 to STA 305 (which may correspond to STA 105-1 and/or STA 105-2 of FIG. 1). The connectivity recommendation 315 notifies STA 305 of other available connection points the STA 305 may utilize when AP 310 enters into a power save mode. The connectivity recommendation 315 contains a list of one or more neighboring APs providing wireless service and/or one or more links of the AP providing wireless service. For example, neighboring APs providing wireless service may comprise nearby APs that are not operating in power save mode (e.g., operating in a fully active mode). In cases where AP 310 comprises an AP MLD with multiple links, the list may also contain available links that are not entering the power save mode. Additionally, in some embodiments, the connectivity request contains an indication of the type of power save mode as well as a schedule for the power save mode (e.g., start time, duration, etc.), so that the STA 305 will know when the power save mode will begin, what action to take, and/or the like. For example, if the AP 310 (or link thereof) is going into power save for a short period of time, the STA 305 may decide to remain associated with the AP 310. Conversely, if the AP 310 (or link thereof) is going into power save for a long period of time, the STA 305 may decide to associate with another AP or link provided in the connectivity recommendation.

Upon receiving the connectivity recommendation from AP 310, STA 305 will be able to take appropriate action to prepare for the upcoming power save mode, such as connecting to other available APs or links of the AP 310 that are not entering the power save mode, which may reduce or eliminate any disruption in wireless service that would otherwise occur. By sending the connectivity recommendation before beginning power save operations, the STA 305 may, in advance, make alternative arrangements for connecting to wireless service rather than suddenly losing wireless service and then seeking a remedy.

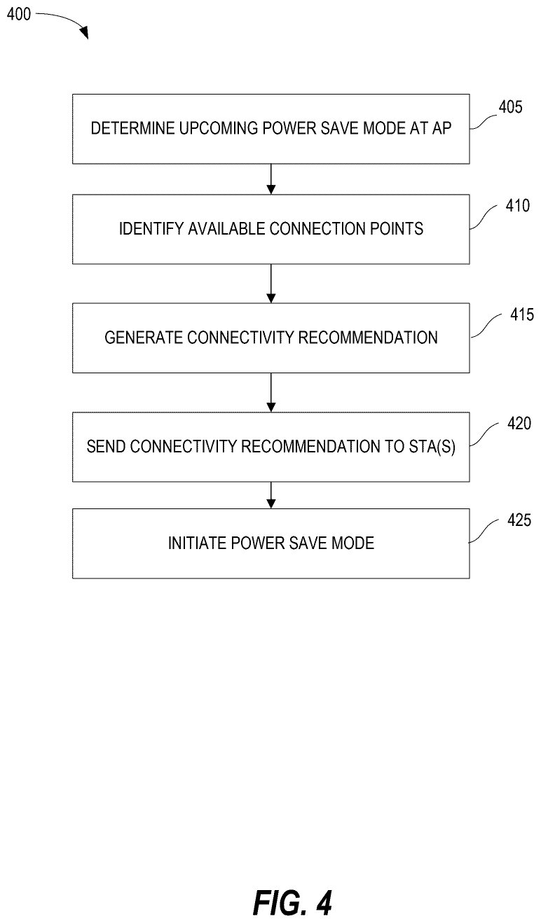

FIG. 4 depicts an example method in which the associated AP generates the connectivity recommendation which is provided to one or more connected STAs, according to some embodiments of the present disclosure. In some embodiments, the method 400 may be performed by one or more network devices, such as AP 110 as depicted in FIG. 1 and AP 310 as depicted in FIG. 3.

At block 405, an AP (e.g., AP 110 of FIG. 1 or AP 310 of FIG. 3), determines to enter a power save mode at a future period of time. In some embodiments, the AP may be an AP MLD comprising multiple links. The entire AP/AP MLD may be entering power save mode or only a subset of the links may be entering the power save mode. The power save mode may involve shutting down operations of the AP completely or reducing the capabilities of the AP, or links thereof (e.g., limiting certain functions, operating at a lower power, and/or the like), according to a particular power save state associated with the power save mode. For example, power save states may comprise a full doze state (i.e., where the AP is shut down for the duration of the power save mode), a doze state with wakeup functionality (i.e., the AP is shut down but may return to active mode when certain traffic is detected), a static low capability state (i.e., the AP operates at a lower power level with reduced capability for the duration of the power save mode), a dynamic power state (i.e., an AP MLD can switch between multiple links and power save states such as via eMLSR), or a compatibility support listen state (i.e., the AP operates in power save mode for some STAs, such as UHR devices, but remains active for other devices), among others.

At block 410, the AP identifies the available, alternative connection point(s) for STAs associated with the AP. As discussed above, the available, alternative connection point(s) include nearby APs and/or links of the AP that are not operating in power save mode and that an STA may connect to for wireless service (e.g., rather than remain connected to the AP or link that is shutting down or reducing power).

At block 415, the AP generates a connectivity recommendation (e.g., connectivity recommendation 315 of FIG. 3) based on the identified connection point(s). The connectivity recommendation generation may be triggered once the amount of time before the power save mode is scheduled to begin falls below a threshold value (e.g., the AP power save mode will begin soon so connected STAs are to be notified). The connectivity recommendation comprises a list of one or more neighboring APs providing wireless service and/or one or more links of the AP providing wireless service. For example, neighboring APs providing wireless service may comprise nearby APs that are not operating in power save mode (e.g., operating in a fully active mode). In cases where AP 310 comprises an AP MLD with multiple links, the list may also contain available links that are not entering the power save mode. Additionally, in some embodiments, the connectivity request contains an indication of the type of power save mode as well as a schedule for the power save mode (e.g., start time, duration, etc.). The recommended connection points, as well as the additional information, enable STAs to decide on and implement a best course of action. For example, a STA may decide to cease scanning if the AP is shutting down, decide to enter into a doze state (e.g., to save power) on the corresponding link of the AP beginning power save operations, while continuing to using other links, or decide to associate with another active AP, or links, provided in the connectivity recommendation.

At block 420, the AP sends the connectivity recommendation to one or more STAs that are connected to the AP (e.g., STA 105-1 and/or STA 105-2 of FIG. 1). The AP sends the connectivity recommendation prior to initializing the power save mode so that the STAs may prepare for the upcoming power save operations (e.g., by altering operations as discussed above). In one embodiment, the AP may send the connectivity recommendation simultaneously with initializing the power save mode (i.e., indicating that the start time is immediate or not including a start time). The connectivity recommendation may be transmitted via a BTM request frame or a neighbor report response frame.

In some embodiments, the transmitting is based on one or more features of each STA of the STAs associated with the AP, such as the type of STA. For example, UHR devices may be provided with an enhanced BTM request frame containing an “AP Power Save” indication. The indication may be added to a request mode field in the BTM request frame or a new reason code field with the “AP Power Save” reason may be added to the BTM request frame. For short term power save (e.g., milliseconds to seconds) with certain pre-UHR devices, such as EHT devices, the AP (or link thereof) may be signaled as disabled for the duration of the power save mode (e.g., by using a TID-to-link mapping (TTLM) element in the BTM request frame). In some embodiments, the TTLM signaling is enhanced to indicate that the link disablement is for AP power save, which may be indicated in the TTLM element using a bit in the TTLM control field or by adding a new field (e.g. a reason code). For long term power save (minutes to hours) with EHT devices, the AP may be signaled as removed, such as by using a reconfiguration multi-link (ML) “AP Removal” feature. The reconfiguration ML element may be enhanced to indicate an AP power save reason for the AP removal (e.g., indicated in the STA control field for an AP or by adding a reason code in the per-STA profile element). If the entire AP MLD is shutting down due to power save, a field or a reason code in the common info field in the reconfiguration ML element may be used, while, if a subset of the AP MLD links are going into power save mode, the AP MLD may send a BTM Request to the EHT devices to suggest the remaining links. For legacy devices (e.g., pre-UHR and pre-EHT), a BTM request may be used to signal that the AP's BSS will be terminated. The AP may set the dissociation imminent field in the BTM request equal to one and indicate the list of BSS transition candidates (e.g., the alternative connection points in the connectivity recommendation).

At block 425, the AP initiates the power save mode. The AP may then operate in the power save mode determined at block 405 (e.g., shutting down, reducing capability, etc.). The AP may continue operating in power save mode for a specified duration (e.g., detailed in the connectivity recommendation) or until the AP wakes up in response to certain traffic (i.e., doze state with wakeup functionality).

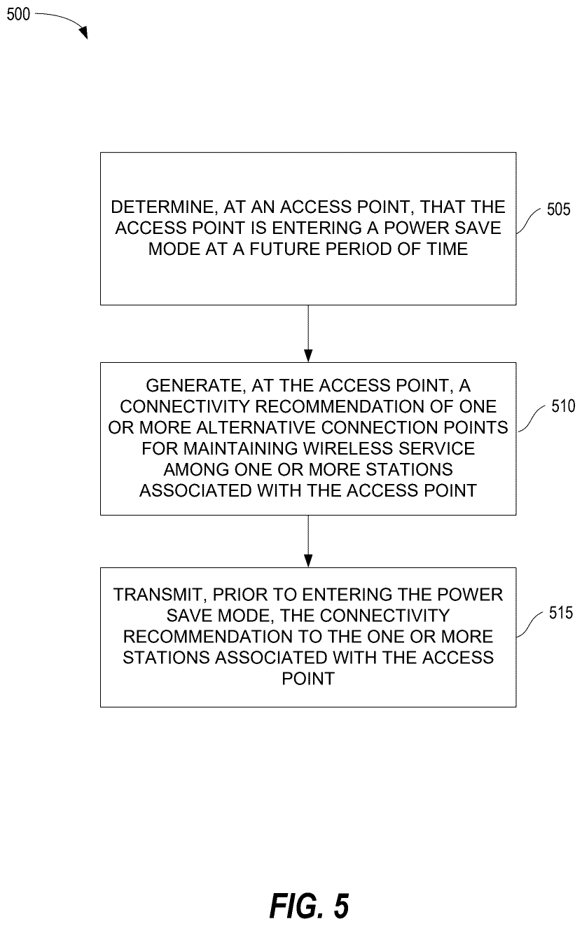

FIG. 5 is a flow diagram depicting an example method 500 for optimizing wireless connectivity, according to some embodiments of the present disclosure.

At block 505, an AP (e.g., AP 110 of FIG. 1 or AP 310 of FIG. 3) determines that the AP is entering a power save mode at a future time (e.g., within a threshold number of seconds, minutes, etc.). As discussed at block 405 of FIG. 4, the power save mode may comprise shutting down operations, reducing capability, and/or the like. In some embodiments, the AP comprises an AP MLD with multiple links where some or all of the links are scheduled to enter the power save mode.

At block 510, the AP generates a connectivity recommendation of one or more alternative connection points for maintaining wireless service among one or more stations associated with the AP, as discussed at block 415 of FIG. 4. The connectivity recommendation (e.g., connectivity recommendation 315 of FIG. 3) may include a list of one or more neighboring APs providing wireless service and/or one or more links of the AP providing wireless service (e.g., as identified at block 410 of FIG. 4). The neighboring APs and links of the AP are not in power save mode (i.e., are fully active and available to provide wireless service to connected STAs). In some embodiments, additional information about the power save mode may be included on the connectivity recommendation for providing to connected STAs. For example, the additional information may comprise a reason for why the AP is entering the power save mode.

At block 515, the AP transmits, prior to entering the power save mode, the connectivity recommendation to the one or more STAs associated with the AP (e.g., STAs 105-1 and 105-2 in FIG. 1 or STA 305 of FIG. 3), as discussed at block 420 of FIG. 4. The transmitting may be based on one or more features of each STA of the STAs associated with the AP. For example, the frame, element, and/or field used for transmitting the connectivity recommendation may differ based on the type of device (e.g., a UHR device, an EHT device, and/or a legacy device). In some embodiments, the connectivity recommendation is transmitted via a BTM request frame or a neighbor report response frame. The connectivity request is transmitted prior to initiating the power save mode (discussed at block 425 of FIG. 4) to allow for any adjustments to be made by the STAs.

In some embodiments, the method further comprises indicating that a particular link of the AP is scheduled to be disabled in the upcoming power save mode, such as by using a TTLM element. In some other embodiments, the method further comprises indicating that the AP is scheduled to be removed in the upcoming power save mode, such as by using a reconfiguration multi-link element.

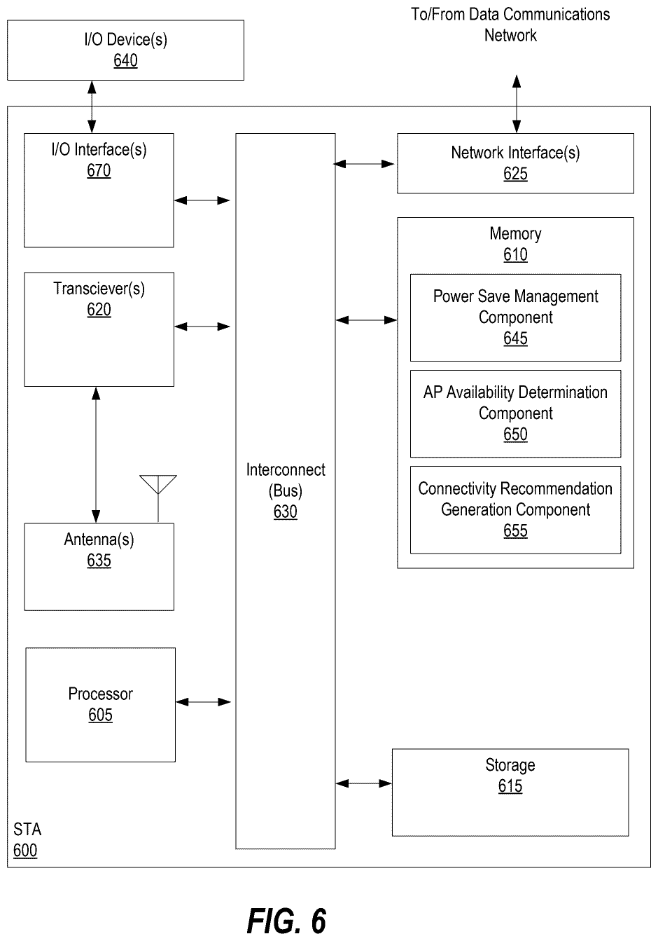

FIG. 6 depicts an example network device 600 configured to perform various aspects of the present disclosure. In some embodiments, the example network device 600 may be an AP or an STA, and communicate with and/or provide support for an associated STA (e.g., which is a device that operates multiple wireless technologies on shared hardware).

As illustrated, the example network device 600 includes a processor 605, memory 610, storage 615, one or more transceivers 620, one or more I/O interfaces 670, and one or more network interfaces 625. In some embodiments, I/O devices 640 are connected via the I/O interface(s) 670. Further, via the network interface 625, the network device 600 can be communicatively coupled with one or more other devices and components (e.g., via a network, which may include the Internet, local network(s), and the like). Each of the components is communicatively coupled by one or more buses 630. In some embodiments, one or more antennas 635 may be coupled to the transceivers 620 for transmitting and receiving wireless signals.

The processor 605 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 605 processes information received through the transceiver 620, I/O interfaces 670, and the network interfaces 625. The processor 605 retrieves and executes programming instructions stored in memory 610, as well as stores and retrieves application data residing in storage 615.

The storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 615 may store a variety of data for the efficient functioning of the system.

The memory 610 may include random access memory (RAM) and read-only memory (ROM). The memory 610 may store processor-executable software code containing instructions that, when executed by the processor 605, enable the network device 600 to perform various functions described herein for wireless communication. In the illustrated example, the memory 610 includes three software components: the power save management component 645, the AP availability determination component 650, and the connectivity recommendation generation component 655.

In one embodiment, the power save management component 645 may manage the power save operations of an AP, such as selecting a type of power save mode, initiating the power save mode, determining the duration of the power save mode, and/or the like.

In one embodiment, the AP availability determination component 650 may identify alternative connection points for STAs associated with the AP, such as neighboring APs and/or links of the AP that are not entering a power save mode.

In one embodiment, the connectivity recommendation generation component 655 may generate, once a power save mode is scheduled to begin, a connectivity recommendation containing an indication of the available links and/or APs (e.g., based on information provided by the AP availability determination component 650), and may send the connectivity recommendation to one or more STAs connected to the AP before the power save mode begins.

To facilitate understanding, identical reference numerals have been used, where possible, to designate identical elements that are common to the figures. It is contemplated that elements disclosed in one embodiment may be beneficially used in other embodiments without specific recitation.

Although depicted as a discrete component for conceptual clarity, in some embodiments, the operations of the depicted components (and others not illustrated) may be combined or distributed across any number of components. Further, although depicted as software residing in memory 610, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
determining, at an access point, to enter a power save mode at a future period of time;
generating, at the access point, a connectivity recommendation of one or more alternative connection points for maintaining wireless service among one or more stations associated with the access point; and
transmitting, prior to entering the power save mode, the connectivity recommendation to the one or more stations associated with the access point.

2. The method of claim 1, wherein the connectivity recommendation comprises a list of one or more of:
one or more neighboring access points providing wireless service; or
one or more links of the access point providing wireless service.

3. The method of claim 2, wherein the one or more neighboring access points and the one or more links of the access point are not operating in a power save state.

4. The method of claim 1, wherein the transmitting, prior to entering the power save mode, the connectivity recommendation to the one or more stations associated with the access point is based on one or more features of each station of the stations associated with the access point.

5. The method of claim 4, wherein the connectivity recommendation is transmitted via one or more of:
a basic service set transition management request frame; or
a neighbor report response frame.

6. The method of claim 1, further comprising providing, in the connectivity recommendation, additional information about the power save mode to the one or more stations associated with the access point, wherein the additional information comprises a reason for entering the power save mode.

7. The method of claim 1, further comprising indicating, in a TID-to-link mapping element, that a link of the access point will be disabled in the power save mode.

8. The method of claim 1, further comprising indicating, in a reconfiguration multi-link element, that the access point will be removed in the power save mode.

9. A system, comprising:
one or more processors; and
one or more memories storing a program, which, when executed on any combination of the one or more processors, performs operations, the operations comprising:
determining, at an access point, to enter a power save mode at a future period of time;
generating, at the access point, a connectivity recommendation of one or more alternative connection points for maintaining wireless service among one or more stations associated with the access point; and
transmitting, prior to entering the power save mode, the connectivity recommendation to the one or more stations associated with the access point.

10. The system of claim 9, wherein the connectivity recommendation comprises a list of one or more of:
one or more neighboring access points providing wireless service; or
one or more links of the access point providing wireless service.

11. The system of claim 10, wherein the one or more neighboring access points and the one or more links of the access point are not operating in a power save state.

12. The system of claim 9, wherein the transmitting, prior to entering the power save mode, the connectivity recommendation to the one or more stations associated with the access point is based on one or more features of each station of the stations associated with the access point.

13. The system of claim 12, wherein the connectivity recommendation is transmitted via one or more of:
a basic service set transition management request frame; or
a neighbor report response frame.

14. The system of claim 9, further comprising providing, in the connectivity recommendation, additional information about the power save mode to the one or more stations associated with the access point, wherein the additional information comprises a reason for entering the power save mode.

15. A non-transitory computer-readable medium containing computer program code that, when executed by operation of one or more computer processors, performs operations comprising:
determining, at an access point, to enter a power save mode at a future period of time;
generating, at the access point, a connectivity recommendation of one or more alternative connection points for maintaining wireless service among one or more stations associated with the access point; and
transmitting, prior to entering the power save mode, the connectivity recommendation to the one or more stations associated with the access point.

16. The non-transitory computer-readable medium of claim 15, wherein the connectivity recommendation comprises a list of one or more of:
one or more neighboring access points providing wireless service; or
one or more links of the access point providing wireless service.

17. The non-transitory computer-readable medium of claim 16, wherein the one or more neighboring access points and the one or more links of the access point are not operating in a power save state.

18. The non-transitory computer-readable medium of claim 15, wherein the transmitting, prior to entering the power save mode, the connectivity recommendation to the one or more stations associated with the access point is based on one or more features of each station of the stations associated with the access point.

19. The non-transitory computer-readable medium of claim 18, wherein the connectivity recommendation is transmitted via one or more of:
a basic service set transition management request frame; or
a neighbor report response frame.

20. The non-transitory computer-readable medium of claim 15, further comprising providing, in the connectivity recommendation, additional information about the power save mode to the one or more stations associated with the access point, wherein the additional information comprises a reason for entering the power save mode.
